(19) United States
(12) Patent Application Publication
(10) Pub. No.: US 2026/0080310 A1
(43) Pub. Date: Mar. 19, 2026

(54) TRAINING METHOD FOR CONTINUAL LEARNING MODEL AND NON-TRANSITORY COMPUTER-READABLE MEDIUM

(71) Applicants: INVENTEC (PUDONG) TECHNOLOGY CORPORATION, Shanghai (CN); INVENTEC CORPORATION, Taipei City (TW)

(72) Inventors: Chih-Fan HSU, Taipei City (TW); Wei-Chao CHEN, Taipei City (TW); Ming-Ching CHANG, Taipei City (TW)

(73) Assignees: INVENTEC (PUDONG) TECHNOLOGY CORPORATION, Shanghai (CN); INVENTEC CORPORATION, Taipei City (TW)

(21) Appl. No.: 19/240,385

(22) Filed: Jun. 17, 2025

(30) Foreign Application Priority Data
Sep. 18, 2024 (CN) 202411304853.4

(51) Int. Cl. G06N 20/00

(52) U.S. Cl. CPC G06N 20/00

(57) ABSTRACT

A training method for continual learning model and a non-transitory computer-readable medium are proposed. The method includes: training the encoder and self-attention layer in the essence generation procedure according to the raw data of a task when the current training process is the first task in continual learning; otherwise, freezing the parameters of the encoder and self-attention layer, performing the essence generation procedure to convert the raw data into a data essence, and adding the data essence into the essence memory. The training process is repeated until the continual learning model converges. The training process includes: obtaining a training batch from the raw data, updating the replay memory according to the training batch, training the continual learning model according to the replay memory and the essence memory, and updating the data essence in the essence memory when the current training process is the first task.

### CROSS-REFERENCE TO RELATED APPLICATIONS

This non-provisional application claims priority under 35 U.S.C. § 119 (a) on Patent Application No(s). 202411304853.4 filed in China on Sep. 18, 2024, the entire contents of which are hereby incorporated by reference.

### BACKGROUND

### 1. Technical Field

The present disclosure relates to Artificial Intelligence (AI) and Machine Learning (ML), and more particularly to a method for training a model using data essence.

### 2. Related Art

Catastrophic forgetting is a major concern in the practical application of AI/ML models. It refers to the phenomenon where a model gradually forgets previously learned data when trained with new data. This leads to a decline in overall classification accuracy, as the model struggles to maintain performance on both old and new data.

A conventional method to address this degradation is to retain a small amount of important data and include it during training with new data. Although this approach may mitigate performance loss to some extent, its effectiveness is limited. Another method involves encoding old data and incorporating the encoded data into the new training process. However, this approach requires the encoding model to be pre-trained on the target data domain. In a continual learning context, future data domains are typically unknown in advance, making it difficult to prepare appropriate training data ahead of time.

### SUMMARY

In view of the above, the objective of the present disclosure is to further reduce the performance degradation of a model caused by training with transitions between old and new data.

According to one or more embodiment of the present disclosure, a training method for continual learning model is performed by a computing device and includes the following steps: initializing a replay memory, an essence memory, and a continual learning model; training an encoder and a self-attention layer in an essence generation procedure according to raw data of one of the plurality of tasks when a current training process is a first of a plurality of tasks in continual learning; otherwise, freezing parameters of the encoder and the self-attention layer; performing the essence generation procedure to convert the raw data into a data essence, and adding the data essence into the essence memory; and repeatedly performing a training procedure until the continual learning model converges. The training procedure includes the following steps: obtaining a training batch from the raw data; updating the replay memory according to the training batch, wherein the replay memory before updating includes a plurality of data from an old training batch; training the continual learning model according to the replay memory and the essence memory; and updating the data essence in the essence memory when the current training process is the first of the plurality of tasks in continual learning.

According to one or more embodiment of the present disclosure, a non-transitory computer-readable medium stores a plurality of instructions for causing a computing device to perform a plurality of operations. The plurality of operations includes: initializing a replay memory, an essence memory, and a continual learning model; training an encoder and a self-attention layer in an essence generation procedure according to raw data of one of a plurality of tasks when a current training process is a first of the plurality of tasks in continual learning; otherwise, freezing parameters of the encoder and the self-attention layer; performing the essence generation procedure to convert the raw data into a data essence, and adding the data essence into the essence memory; and repeatedly performing a training procedure until the continual learning model converges. The training procedure includes the following steps: obtaining a training batch from the raw data; updating the replay memory according to the training batch, wherein the replay memory before updating includes a plurality of data from an old training batch; training the continual learning model according to the replay memory and the essence memory; and updating the data essence in the essence memory when the current training process is the first of the plurality of tasks in continual learning.

In summary, the present disclosure provides a training method for a continual learning model and a non-transitory computer-readable medium for performing the method. The proposed method does not impose restrictions on the type of encoder and allows the use of publicly available models as the encoder. During the first task of the continual learning model training phase, the proposed method fine-tunes the parameters of the encoder and the self-attention layer so that the continual learning model may adapt to the current task. This approach is referred to as the “first session adaption” in the present disclosure.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a flowchart of a training method for a continual learning model according to an embodiment of the present disclosure;

FIG. 2 and FIG. 3 are respectively a schematic diagram and a flowchart of the essence generation procedure according to an embodiment of the present disclosure;

FIG. 4 is a flowchart of a training procedure according to an embodiment of the present disclosure;

FIG. 5 is a flowchart of a method for updating the replay memory according to an embodiment of the present disclosure;

FIG. 6 is a flowchart of an experience blending algorithm according to an embodiment of the present disclosure; and

FIG. 7 and FIG. 8 are block diagrams of the first model and the second model, respectively.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present disclosure. The following embodiments further illustrate various aspects of the present disclosure, but are not meant to limit the scope of the present disclosure.

The present disclosure provides a training method for a continual learning model, suitable for execution by a computing device. In an embodiment, the computing device may adopt at least one of the following examples: a personal computer, a network server, a central processor unit (CPU), a graphic processing unit (GPU), a microcontroller (MCU), an application processor (AP), a field programmable gate array (FPGA), an application-specific integrated circuit (ASIC), a system-on-a-chip (SoC), a deep learning accelerator, or any electronic device with similar functionality. The present disclosure does not limit the hardware type of the computing device. The present disclosure further provides a non-transitory computer-readable medium for storing a plurality of instructions, the plurality of instructions, when executed by the computing device, cause a plurality of operations corresponding to the training method for the continual learning model according to an embodiment of the present disclosure.

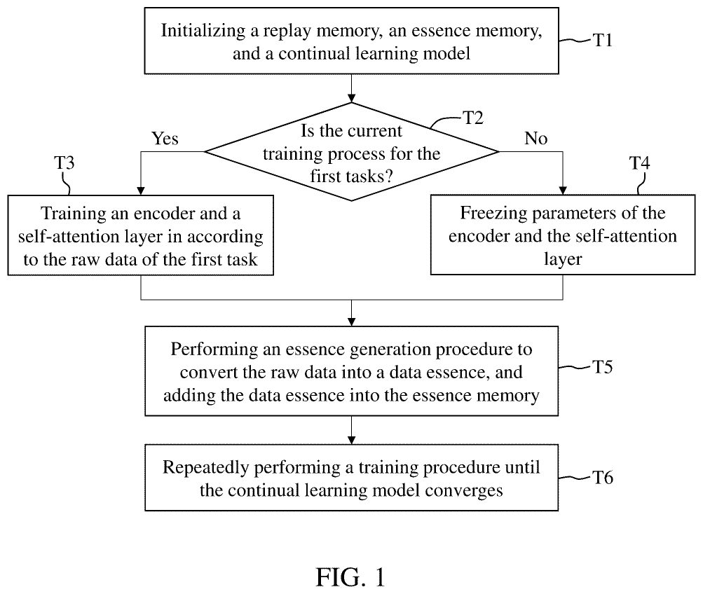

FIG. 1 is a flowchart of a training method for a continual learning model according to an embodiment of the present disclosure, including steps T1 to T6. Continual learning (CL) refers to continuously updating a model by sequentially performing a plurality of tasks in chronological order. Pseudocode corresponding to the method shown in FIG. 1 is provided in Table 1. Please refer to both FIG. 1 and Table 1.

TABLE 1
pseudocode of the training method
for the continual learning model.

| | |
|---|---|
| 01 | Initialize replay memory [symbol] , essence memory ε, model [symbol] |
| 02 | for each task i do |
| 03 | if i = 0 then |
| 04 | Train [symbol] and the SA layer |
| 05 | else |
| 06 | Freeze [symbol] and the SA layer |
| 07 | Eⁱ ← EssenceGeneration(Rⁱ) |
| 08 | ε ← ε ∪ Eⁱ |
| 09 | repeat |
| 10 | Obtain a training batch B |
| 11 | [symbol] ← ImportanceSampling(B, [symbol] , [symbol] ) |
| 12 | [symbol] ← ExperienceBlending(ε, [symbol] , [symbol] ) |
| 13 | if i = 0 then |
| 14 | Update E⁰ in ε |
| 15 | until model [symbol] converges |
| 16 | end for |

As shown in step T1 and line 01, the computing device initializes a replay memory [symbol] , an essence memory ε, and a continual learning model [symbol] . The replay memory R is configured to store training data, and the essence memory ε is configured to store data essence extracted from the training data. The memories [symbol] , ε may be implemented using either physical or virtual storage space. The present disclosure does not limit the implementation of the memories [symbol] , ε to hardware or software. In an embodiment, the memories [symbol] , ε may be implemented using Network Attached Storage (NAS).

As shown in step T2 and lines 02-03, the computing device determines whether the current training process is the first task. If so, step T3 is performed; otherwise, step T4 is performed. The distinction between tasks is made according to predefined CL parameters. For example, one task may correspond to N datasets or N classes within the same dataset. The present disclosure does not impose any limitation on this definition.

As shown in step T3 and line 04, the computing device trains an encoder [symbol] and a self-attention (SA) layer according to the raw data of the first task. The raw data may include at least one of datasets such as CIFAR-10, CIFAR-100, TinyImageNet, and ImageNet. The present disclosure is not limited to these datasets. The encoder [symbol] may be a deep learning model for image classification pre-trained on large-scale datasets, such as EfficientNet, ResNet, VGG, or Vision Transformer. The SA layer may be, for example, the self-attention module from the Self-Attention Generative Adversarial Networks (SAGAN).

As shown in step T4 and line 06, the computing device freezes the parameters of the encoder [symbol] and the SA layer. After completing either step T3 or T4, step T5 is performed.

As shown in step T5 and lines 07-08, the computing device performs an essence generation procedure EssenceGeneration( ) to convert the raw data Rⁱ of the i-th task into the data essence Eⁱ of the i-th task, and adds the data essence Eⁱ to the essence memory E. In continual learning scenarios, it is generally not possible to obtain the raw data used in previous training tasks. To prevent the continual learning model [symbol] from experiencing performance degradation due to catastrophic forgetting in subsequent training tasks, the present disclosure extracts and stores the data essence from the raw data of the current task.

As shown in step T6 and lines 09-15, the computing device repeatedly executes a training procedure until the continual learning model [symbol] converges.

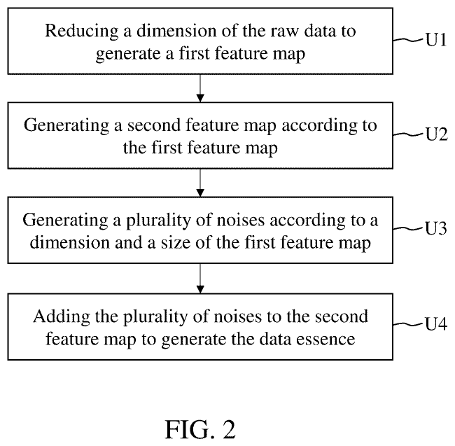

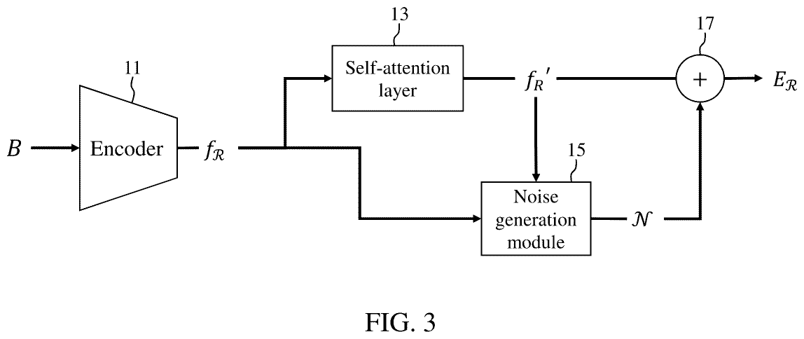

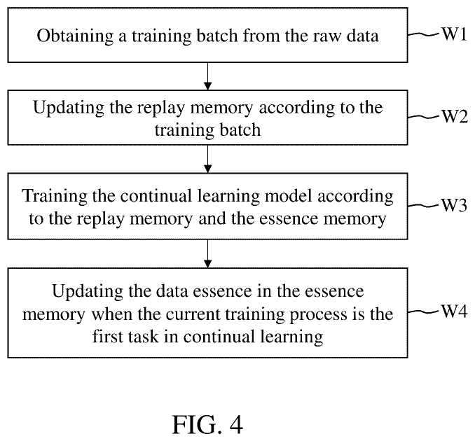

The following explains the method of generating data essence with reference to FIG. 2 and FIG. 3, and describes the details of the training procedure with reference to FIG. 4 through FIG. 8.

FIG. 2 and FIG. 3 are respectively a schematic diagram and a flowchart of the essence generation procedure according to an embodiment of the present disclosure.

In step U1, the encoder 11 reduces the dimension of the raw data R to generate a first feature map [symbol] . In an embodiment, the first feature map [symbol] is the output image of a convolutional layer within the encoder 11, comprising a plurality of positions. To reduce computational cost of the computing device, the raw data Rⁱ may be divided into a plurality of training batches B and input into the encoder 11 batch by batch.

In step U2, a self-attention layer generates a second feature map [symbol] according to a plurality of similarities between any two positions in the first feature map. For example, a 2×2 first feature map as shown in Table 2 below has four positions A, B, C, and D. Based on this first feature map, a 4×4 attention map as shown in Table 3 may be generated, containing 16 values such as (A, A), (A, B), . . . , (D, D), where (X, Y) represents the correlation between position X and position Y. The second feature map [symbol] may be generated by applying softmax operation, dot product operation, and 1×1 convolution operation on the attention map.

TABLE 2
example of the first feature map:

| | |
|---|---|
| A | B |
| C | D |

TABLE 3
example of the attention map:

| | | | |
|---|---|---|---|
| (A, A) | (A, B) | (A, C) | (A, D) |
| (B, A) | (B, B) | (B, C) | (B, D) |
| (C, A) | (C, B) | (C, C) | (C, D) |
| (D, A) | (D, B) | (D, C) | (D, D) |

At step U3, a noise generation module 15 generates a plurality of noises [symbol] according to the dimension and size of the first feature map [symbol] . In an embodiment, the noise generation module 15 generates a plurality of Laplace noises

$$Lap ( λ ) = Lap ( 0 , \frac{τ}{λ \vert B \vert} ) ,$$

where τ is the difference between the maximum and minimum values in the training batch B, |B| is the number of data in the training batch B, and λ is a user-adjustable parameter, where a smaller λ indicates stronger noise. In another embodiment, the noise generation module 15 generates a plurality of Gaussian noises. The purpose of adding noise [symbol] is to simulate the fuzziness of human memory.

In step U4, the computing device executes an adder 17 to add the plurality of noises [symbol] to the second feature map [symbol] to generate the data essence [symbol] .

FIG. 4 is a flowchart of a training procedure according to an embodiment of the present disclosure, including steps W1 to W4.

In step W1 (corresponding to line 10 in Table 1), the computing device obtains a training batch B from the raw data. The training batch B may include, for example, N pieces of data/images, data/images from N categories, or data/images from N datasets. The present disclosure does not limit the form of the training batch B.

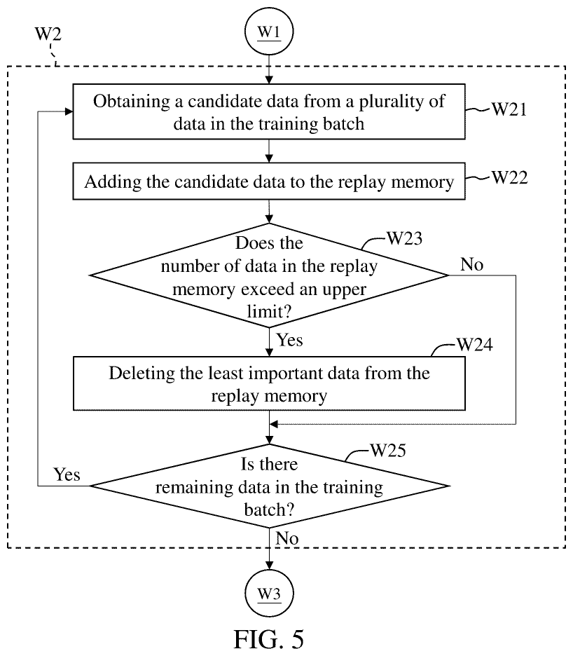

In step W2 (corresponding to line 11 in Table 1), the computing device updates the replay memory [symbol] according to the training batch B. The replay memory [symbol] before updating includes a plurality of data from an old training batch. For implementation details of step W2, please refer to FIG. 5.

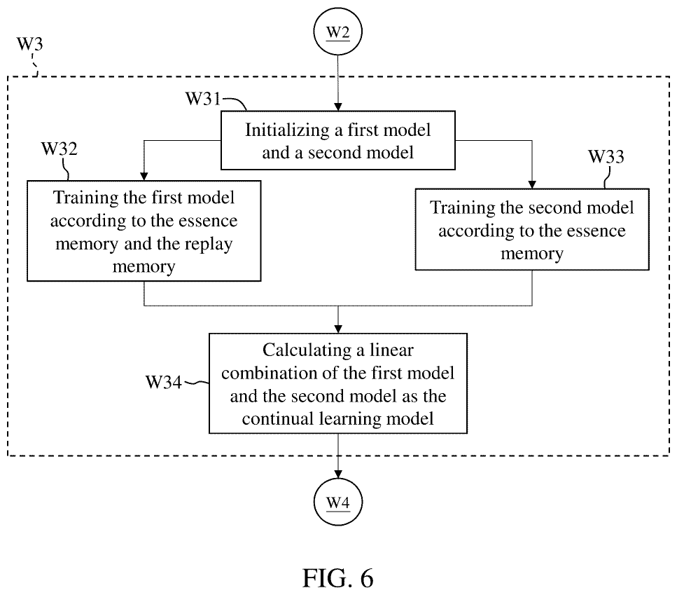

In step W3 (corresponding to line 12 in Table 1), the computing device trains the continual learning model [symbol] according to the replay memory [symbol] and the essence memory ε. For implementation details of step W3, please refer to FIG. 6. The algorithm corresponding to step W3 is referred to as “experience blending” in the present disclosure.

In step W4 (corresponding to lines 13 to 15 in Table 1), if the current training process is the first task in continual learning, the computing device updates the data essence in the essence memory E. Otherwise, the computing device performs no operation. After step W4 is completed, if the continual learning model [symbol] has not yet converged, the process returns to step W1, where the computing device obtains the next training batch B to continue training the continual learning model [symbol] .

FIG. 5 is a flowchart of a method for updating the replay memory according to an embodiment of the present disclosure, including steps W21 to W25. Table 4 provides the pseudocode corresponding to this method. Please refer to both FIG. 5 and Table 4.

TABLE 4
pseudocode for Updating the Replay Memory

| | |
|---|---|
| 40 | function ImportanceSampling(B, [symbol] , [symbol] ) |
| 41 | for each sample b in B do |
| 42 | [symbol] ← [symbol] ∪ b |
| 43 | if \| [symbol] \| > s then |
| 44 | Remove the least important sample in [symbol] with respect to [symbol] |
| 45 | return [symbol] |

In step W21 (corresponding to line 41 in Table 4), the computing device selects a candidate data b from the plurality of data in the training batch B.

In step W22 (corresponding to line 42 in Table 4), the computing device adds the candidate data b to the replay memory [symbol] .

In step W23 (corresponding to line 43 in Table 4), the computing device determines whether the number of data | [symbol] | in the replay memory [symbol] exceeds an upper limit s. If so, step W24 is performed; otherwise, step W25 is performed.

In step W24 (corresponding to line 44 in Table 4), the computing device deletes data least important to the continual learning model [symbol] from the replay memory [symbol] . In an embodiment, when the continual learning model [symbol] is trained using the training batch B, the loss difference before and after training is measured for each candidate data b. If the loss decreases, the importance score of the candidate data b increases. Accordingly, the least important data is identified as having the lowest importance score. Through this mechanism, data with higher importance may be selected from the training batch B and stored in the replay memory [symbol] .

In step W25, the computing device checks whether there are remaining data in the training batch B. If yes, it returns to step W21. If not, it proceeds to step W3.

FIG. 6 is a flowchart of an experience blending algorithm according to an embodiment of the present disclosure, including steps W31 to W34. Table 5 provides the pseudocode for the experience blending algorithm. Please refer to both FIG. 6 and Table 5.

TABLE 5
pseudocode for Experience Blending Algorithm

| | |
|---|---|
| 50 | function ExperienceBlending(ε, [symbol] , [symbol] ) |
| 51 | Initialize [symbol] _{R&E} and [symbol] _{E} with [symbol] |
| 52 | Train [symbol] _{R&E} with ε ∪ [symbol] |
| 53 | Train [symbol] _{E} with ε |
| 54 | [symbol] ← α [symbol] _{R&E} + (1 − α) [symbol] _{E} |
| 55 | Return [symbol] |

In step W31 (corresponding to line 51 of Table 5), the computing device initializes a first model [symbol] _{R&E} and a second model [symbol] _{E} according to the architecture of the continual learning model [symbol] .

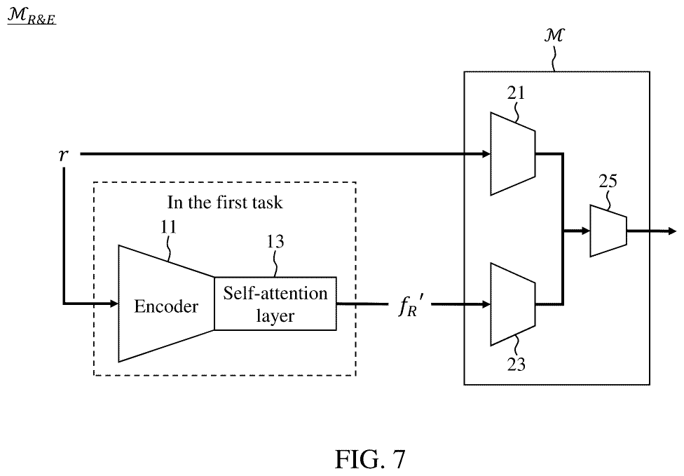

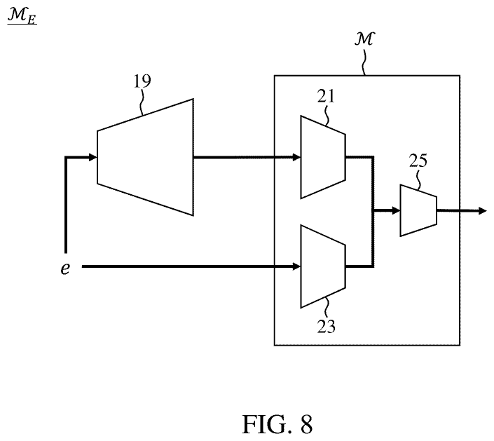

FIG. 7 and FIG. 8 are block diagrams of the first model [symbol] _{R&E} and the second model [symbol] _{E}, respectively. As shown in FIG. 7 and FIG. 8, the first model [symbol] _{R&E} and the second model [symbol] _{E} are both derived from the architecture of continual learning model [symbol] , but they are trained separately using different data. The continual learning model [symbol] includes a first feature generator 21, a second feature generator 23, and a classifier 25. In an embodiment, the first feature generator 21 and the second feature generator 23 may be implemented using models such as ResNet, VGG, MLP, or Vision Transformer, although the present disclosure is not limited thereto.

In step W32 (corresponding to line 52 of Table 5), the computing device trains the first model [symbol] _{R&E} using the essence memory ε and the replay memory [symbol] . As illustrated in FIG. 7, the first feature generator 21 generates a first feature according to the raw data r, the second feature generator 23 generates a second feature according to the input, and the classifier 25 performs a classification according to the concatenation of the first feature and the second feature, ultimately outputting a classification result.

It should be noted that there are two types of inputs to the second feature generator 23. If the current training task is the first task, the input to the second feature generator 23 is the second feature map [symbol] , which is generated by the encoder 11 and the attention layer 13 according to the raw data r. If the current training task is the second or a subsequent task, the input to the second feature generator 23 is the raw data r itself. In an embodiment, the loss function for the first model [symbol] _{R&E} is defined as L_{R&E}= [symbol] + [symbol] , where [symbol] denotes the cross-entropy loss function.

In step W33 (corresponding to line 53 of Table 5), the computing device trains the second model [symbol] _{E}, according to the essence memory ε. Since the data essence e differs from the raw data r, the model architecture needs to be modified to recognize the data essence e and restore the data essence e to the form of the raw data r. The modified architecture is shown in FIG. 8, where a generative model 19 generates a data anchor according to the data essence e, the first feature generator 21 generates the first feature according to the data anchor, the second feature generator 23 generates the second feature according to the data essence e, and the classifier 25 performs a classification according to the concatenation of the first feature and the second feature, ultimately outputting a classification result. In an embodiment, the generative model 19 may be implemented using a Generative Adversarial Network (GAN), a Variational Autoencoder (VAE), an autoregressive model, or a Transformer-based model (e.g., Image GPT). The loss function for the second model [symbol] _{E}, is defined as L_{E}= [symbol] (M_{E}, ε).

In step W34 (corresponding to line 54 of Table 5), the computing device calculates a linear combination of the first model [symbol] _{R&E} and the second model [symbol] _{E} to form the continual learning model [symbol] . Since the first model [symbol] _{R&E} and the second model [symbol] _{E} have similar architectures, corresponding parameters from both models may be linearly combined by multiplying with weights α and (1-α), respectively, and then summing them to produce the parameters of the continual learning model [symbol] . In an embodiment, α=0.5.

TABLE 6
accuracy comparison between existing
methods and the present disclosure

| Method | CIFAR-10 | CIFAR-100 | Tiny ImageNet |
|---|---|---|---|
| Joint Training | 96.03 | 79.89 | 53.05 |
| RM | 61.52 ± 3.69 | 33.27 ± 1.59 | 17.04 ± 0.77 |
| GDumb | 55.27 ± 2.69 | 34.03 ± 0.89 | 18.69 ± 0.45 |
| EWC++ | 60.33 ± 2.73 | 38.78 ± 2.32 | 24.39 ± 1.18 |
| ER-MIR | 61.93 ± 3.35 | 38.28 ± 1.15 | 24.54 ± 1.26 |
| BiC | 61.49 ± 0.68 | 37.61 ± 3.00 | 24.90 ± 1.07 |
| CLIB | 73.90 ± 0.22 | 49.22 ± 0.79 | 25.05 ± 0.52 |
| iCaRL | 68.77 ± 2.88 | 33.55 ± 0.58 | 25.41 ± 0.55 |
| FOSTER | 73.40 ± 1.20 | 52.80 ± 0.15 | 33.93 ± 0.47 |
| The present disclosure | 84.35 ± 1.06 | 58.51 ± 0.66 | 47.02 ± 0.75 |

RM: Rainbow Memory: Continual Learning with a Memory of Diverse Samples
GDumb: A Simple Approach that Questions Our Progress in Continual Learning
EWC++: Riemannian Walk for Incremental Learning: Understanding Forgetting and Intransigence
ER-MIR: Online Continual Learning with Maximally Interfered Retrieval
BiC: Large Scale Incremental Learning
CLIB: Online continual learning on class incremental blurry task configuration with anytime inference
iCaRL: Incremental Classifier and Representation Learning.
FOSTER: Feature Boosting and Compression for Class-Incremental Learning.

In Table 6, joint training represents a scenario in the continual learning process where all data is accessible at any time; therefore, its accuracy serves as the upper bound. Therefore, the closer the accuracy is to the value achieved by joint training, the more effectively the continual learning model can mitigate the problem of catastrophic forgetting. As shown in Table 6, the training method for the continual learning model proposed in the present disclosure outperforms existing methods across all datasets.

TABLE 7
comparison of different encoders.

| | Dataset | CIFAR-10 | CIFAR-100 | Tiny ImageNet |
|---|---|---|---|---|
| Encoder | CIFAR-10 | 94.62 | 41.42 | 22.48 |
| | CIFAR-100 | 79.14 | 66.79 | 28.21 |
| | Tiny ImageNet | 80.79 | 52.61 | 49.95 |
| | ImageNet | 84.35 | 58.51 | 47.02 |

Table 7 presents the accuracy of the continual learning model on the target dataset when using encoders trained on a different dataset. As shown in Table 7, the average accuracy of the continual learning model is proportional to the size of the dataset used to train the encoder. In other words, if the encoder is pretrained on a sufficiently large dataset, or if a foundation model is adopted as the encoder, the accuracy of the continual learning model is expected to improve.

In summary, the present disclosure provides a training method for a continual learning model and a non-transitory computer-readable medium for performing the method. The proposed method does not impose restrictions on the type of encoder and allows the use of publicly available models as the encoder. During the first task of the continual learning model training phase, the proposed method fine-tunes the parameters of the encoder and the self-attention layer so that the continual learning model may adapt to the current task. This approach is referred to as the “first session adaption” in the present disclosure.

Moreover, to reduce performance degradation caused by the transition between new and old data during training, the present disclosure utilizes data essence to train the continual learning model. The underlying concept mimics human memory storage, where less important parts gradually fade while important parts remain vivid. Based on this idea, the method proposed in the present disclosure transforms old data into highly refined data essence and stores it. During the training of a new task, a generative model is used to reconstruct the data essence into the form of the raw data, which is then combined with the raw data of the new task to train the continual learning model. This helps the model retain previously learned knowledge and reduces performance degradation caused by model updates. This mechanism is analogous to how humans recall past events through the vivid parts of a blurry memory.

What is claimed is:

1. A training method for continual learning model, performed by a computing device, comprising:
initializing a replay memory, an essence memory, and a continual learning model;
training an encoder and a self-attention layer in an essence generation procedure according to raw data of one of a plurality of tasks when a current training process is a first of the plurality of tasks in continual learning; otherwise, freezing parameters of the encoder and the self-attention layer;
performing the essence generation procedure to convert the raw data into a data essence, and adding the data essence into the essence memory; and
repeatedly performing a training procedure until the continual learning model converges, the training procedure comprising:
obtaining a training batch from the raw data;
updating the replay memory according to the training batch, wherein the replay memory before updating includes a plurality of data from an old training batch;
training the continual learning model according to the replay memory and the essence memory; and
updating the data essence in the essence memory when the current training process is the first of the plurality of tasks in continual learning.

2. The training method for continual learning model of claim 1, wherein the essence generation procedure comprises:
reducing a dimension of the raw data by the encoder to generate a first feature map, wherein the first feature map comprises a plurality of positions;
generating a second feature map by the self-attention layer according to a plurality of similarities between any two of the plurality of positions;
generating a plurality of noises by a noise generation module according to the dimension and a size of the first feature map; and
adding the plurality of noises to the second feature map to generate the data essence.

3. The training method of a continual learning model of claim 1, wherein updating the replay memory according to the training batch comprises:
obtaining a candidate data from a plurality of data in the training batch;
adding the candidate data to the replay memory; and
deleting data least important to the continual learning model from the replay memory when a number of data in the replay memory exceeds an upper limit.

4. The training method of a continual learning model of claim 1, wherein training the continual learning model according to the replay memory and the essence memory comprises:
initializing a first model and a second model according to an architecture of the continual learning model;
training the first model according to the essence memory and the replay memory;
training the second model according to the essence memory; and
calculating a linear combination of the first model and the second model as the continual learning model.

5. A non-transitory computer-readable medium storing a plurality of instructions for causing a computing device to perform a plurality of operations, with the plurality of operations comprising:
initializing a replay memory, an essence memory, and a continual learning model;
training an encoder and a self-attention layer in an essence generation procedure according to raw data of one of a plurality of tasks when a current training process is a first of the plurality of tasks in continual learning; otherwise, freezing parameters of the encoder and the self-attention layer;
performing the essence generation procedure to convert the raw data into a data essence, and adding the data essence into the essence memory; and
repeatedly performing a training procedure until the continual learning model converges, the training procedure comprising:
obtaining a training batch from the raw data;
updating the replay memory according to the training batch, wherein the replay memory before updating includes a plurality of data from an old training batch;
training the continual learning model according to the replay memory and the essence memory; and
updating the data essence in the essence memory when the current training process is the first of the plurality of tasks in continual learning.

6. The non-transitory computer-readable medium of claim 5, wherein the essence generation procedure comprises:
reducing a dimension of the raw data by the encoder to generate a first feature map, wherein the first feature map comprises a plurality of positions;
generating a second feature map by the self-attention layer according to a plurality of similarities between any two of the plurality of positions;
generating a plurality of noises by a noise generation module according to the dimension and a size of the first feature map; and
adding the plurality of noises to the second feature map to generate the data essence.

7. The non-transitory computer-readable medium of claim 5, wherein updating the replay memory according to the training batch comprises:
obtaining a candidate data from a plurality of data in the training batch;
adding the candidate data to the replay memory; and
deleting data least important to the continual learning model from the replay memory when a number of data in the replay memory exceeds an upper limit.

8. The non-transitory computer-readable medium of claim 5, wherein training the continual learning model according to the replay memory and the essence memory comprises:
initializing a first model and a second model according to an architecture of the continual learning model;
training the first model according to the essence memory and the replay memory;
training the second model according to the essence memory; and
calculating a linear combination of the first model and the second model as the continual learning model.
